(19) United States
(12) Patent Application Publication
(10) Pub. No.: US 2022/0260117 A1
(43) Pub. Date: Aug. 18, 2022

(54) BEARING UNIT PROVIDED WITH A RETENTION DEVICE HAVING OPTIMIZED LUBRICATION

(71) Applicants: AKTIEBOLAGET SKF, Goteborg (SE); SKF ENGINEERING AND LUBRICATION INDIA PRIVATE LIMITED, Bangalore (IN)

(72) Inventors: Fausto Morello, Sommariva del Bosco (IT); Silambarasan Chidambaram, Harur (IN)

(21) Appl. No.: 17/665,887

(22) Filed: Feb. 7, 2022

(30) Foreign Application Priority Data
Feb. 15, 2021 (IT) 102021000003272

(51) Int. Cl. F16C 33/66; F16C 19/16; F16C 33/38

(52) U.S. Cl. CPC F16C 33/6681; F16C 33/3887; F16C 19/16

(57) ABSTRACT

A bearing unit provided with a radially outer ring, a radially inner ring, a plurality of rolling bodies interposed between the radially outer ring and the radially inner ring, and a retention device for keeping in position the plurality of rolling bodies, having a circular base rib, a plurality of fingers circumferentially spaced and defining a plurality of cavities for holding respective rolling bodies of the plurality of rolling bodies which are in contact with the retention device by means of a contact surface, and a plurality of discontinuity elements which reduce the extent of the area of contact with the rolling bodies.

### CROSS-REFERENCE TO RELATED APPLICATIONS

This application is based on and claims priority to Italian Patent Application No. 10202100003272 filed on Feb. 15, 2021, under 35 U.S.C. § 119, the disclosure of which is incorporated by reference herein.

### FIELD

The present disclosure relates to a bearing unit for a wheel hub assembly.

### BACKGROUND

A wheel hub assembly provided with a bearing unit for rotatably supporting a wheel of a vehicle on a suspension system is known and commonly used. The bearing unit, in general, includes a pair of rolling bearings, but different configurations of the bearing unit to which the present disclosure may be applied are also known. Rolling bearings may be retained within a rolling bearing by a retention device.

### BRIEF DESCRIPTION OF THE DRAWINGS

The attached drawings illustrate various non-limiting exemplary embodiments in accordance with this disclosure, in which:

FIG. 1 is a cross-sectional view of various embodiments of a wheel hub assembly provided with a bearing unit in accordance with this disclosure;

FIG. 2 is a detail view of various embodiments of a wheel hub assembly according to FIG. 1, which has a retention device for retaining a plurality of rolling bodies, designed to ensure an optimized lubrication for the rolling bodies, according to various exemplary embodiments in accordance with this disclosure;

FIG. 3 shows a retention device for retaining the rolling bodies, according to various embodiment in accordance with this disclosure; and

FIG. 4 is a detail view of various embodiments of a retention device for retaining the rolling bodies according to FIG. 3 in accordance with this disclosure.

### DETAILED DESCRIPTION

Wheel hub assemblies provided with bearing units for rotatably supporting a wheel of a vehicle on a suspension system generally includes a pair of rolling bearings, but different configurations of bearing units are also known.

In various examples, a rotatable hub is provided with a coupling for engaging a rotating element of a motor vehicle, for example a wheel or a disc of a braking element, while bearing units typically include an outer ring, a pair of inner rings, one of which may be the wheel hub itself, and a plurality of rolling bodies, e.g., balls, rollers or tapered rollers. All these components have axial symmetry with respect to an axis of rotation of the rotating elements, for example a wheel hub and inner rings of an exemplary bearing unit.

Also as a result of the ever-increasing global competition, there is a constant demand, e.g., from automotive manufacturers, for continuous technical-related or cost-related improvements to wheel hub assemblies. In particular, with the development of technology, demand for components with relatively low energy dissipation is increasing, while demand for ensuring the same or better performance compared to known solutions remains unchanged.

One source of energy dissipation identified in wheel hub assemblies is rolling friction which is generated between raceways of a bearing unit and rolling bodies of such a bearing unit. This drawback results in a succession of other additional problems. Firstly, a cause of friction is that lubricants inserted in a bearing unit—e.g., normally bearing grease, but sometimes also lubricating oil, fails to spread over all intended contact surfaces. This defect in lubricating technology has direct consequence by increasing (or failing to decrease) fatigue resistance of such bearing unit in general, and of the raceways in particular. Another consequence identified, from a performance point of view, is that such bearing units cannot be used in high-temperature applications.

One way of reducing friction in bearing units is to improve a surface finish of raceways within such bearing units. However, improving surface finish results in a significant increase in cost of resulting bearing units.

There we have identified a need for a bearing unit with reduced friction that overcomes the aforementioned resultant drawbacks.

In order to solve substantially the aforementioned technical problems, one object of the present disclosure is to define bearing units provided with retention devices for retaining rolling bodies that is configured to ensure a sufficient flow of lubricant to all intended surfaces.

. In embodiments in accordance with this disclosure rolling bodies are constantly and uniformly lubricated, resulting in a reduction in friction between rolling bodies and raceways which in turn increases in a working life of such bearing unit.

Techniques and components in accordance with this disclosure may be applied to all generations of wheel hub assemblies. In particular, embodiments in accordance with this disclosure are applicable in configuration having an outer ring of a bearing unit that is rotatable, while inner rings of are fixed, and opposite configurations where inner rings rotate and an outer ring is fixed.

Exemplary embodiments are described herein with reference to a bearing unit 30, a wheel hub assembly for motor vehicles provided with a bearing unit.

In the whole of the present disclosure, the terms and expressions indicating positions and orientations, such as “radial” and “axial” are understood as being in relation to a central axis X of rotation of a bearing unit 30. Expressions such as “axially outer” and “axially inner,” instead, refer to an assembled configuration of a wheel hub assembly and, in the case in question, preferably relate to a wheel side and, respectively, a side opposite to the wheel side.

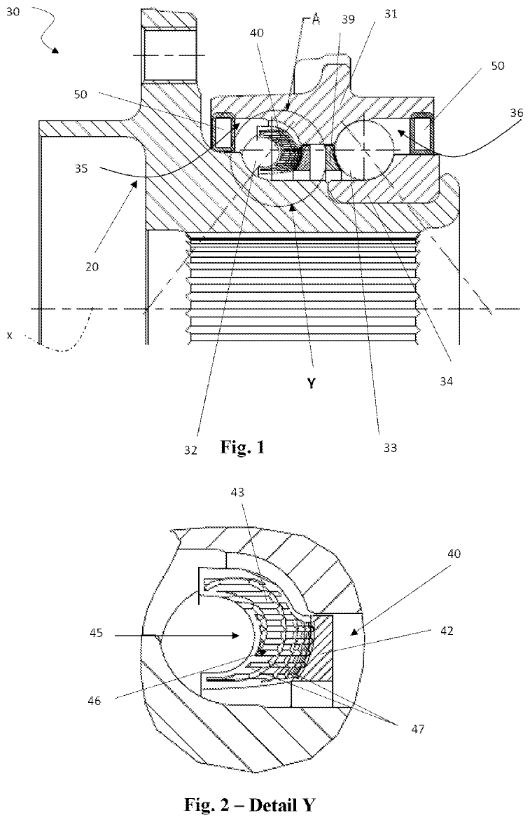

With reference to FIG. 1, a bearing unit 30 may have a central axis X. A bearing unit 30 may include a flanged radially inner ring 20, a radially outer ring 31, and a plurality of rolling bodies 32, 33, which may be balls or rollers, interposed between outer ring 31 and flanged inner ring 20. In some embodiments, inner ring 20 is rotatable about axis X and outer ring 31 is stationary. In another embodiment, inner ring 20 is stationary and outer ring 31 is rotatable about axis X. A bearing unit 30 in accordance with the present disclosure may further include a second rotatable radially inner ring 34 that is mounted on and integral with flanged inner ring 20 and retention devices 39, 40 for retaining rolling bodies 32, 33.

In various embodiments, a radially outer ring 31 may define two radially outer raceways, while a radially flanged inner ring 20 and a second radially inner ring 34 may define respective radially inner raceways (not depicted) for allowing a plurality of rolling bodies 32, 33 to roll between rings 31, 20, and 34 of a bearing unit 30.

A flanged inner ring 20 and a radially outer ring 31 may define, between them and at opposite axial end of a bearing unit 30, an interspace 35 and an interspace 36 which are suitably shielded by a sealing device 50 mounted inside at least one of interspace 35 and interspace 36.

With reference to Figures, 2, 3 and 4, a retention device 40, e.g., a cage, according to various embodiments in accordance with the present disclosure, may include a circular base rib 42 and a plurality of fingers 43 spaced circumferentially about base rib 42 and extending from base rib 42. In at least one embodiment, retention device 40 may be made of a polymeric material. In other embodiments, retention device 40 may be made of bronze. It will be appreciated upon a full reading of this disclosure that a retention device 40 may be made of any suitable material, and the examples provided herein are provided as non-limiting examples.

Base rib 42 and fingers 43 may have partially spherical concave surfaces defining together a plurality of recesses or partially spherical cavities 45 for retaining each of a plurality of rolling bodies, e.g., 32, 33, which may be in contact with retention device 40 by means of a contact surface 46. Contact surface 46 may have a plurality of discontinuity elements 47, 48 which reduce an area of contact between retention device 40 and each of the plurality of rolling bodies 32, 33.

In various exemplary embodiments, a plurality of discontinuity elements 47, 48 may be raised with respect to contact surface 46. In some such embodiments, each of a plurality of discontinuity elements 47, 48 may define an area of contact with respective ones of each of a plurality of rolling elements 32, 33. In another exemplary embodiment, a plurality of discontinuity elements 47, 48 may be inset, e.g., consist of a plurality of incisions recessed into contact surface 46. In such an embodiment, an area of contact with a rolling body, e.g., 32, 33 may be defined by an area of contact with contact surface 46. Therefore, in any case, an area of contact between rolling bodies 32, 33 and a retention device 40 is reduced relative to embodiments that omit discontinuity elements.

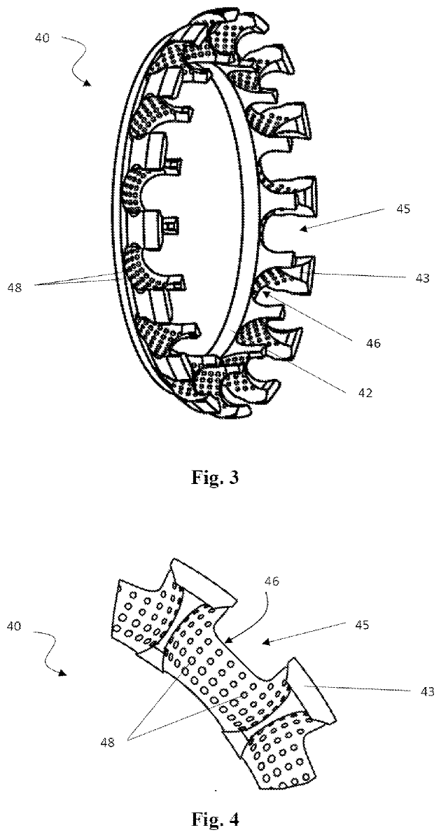

Discontinuity elements 47, 48 may be made using known processing technology, e.g., by means of electro-erosion machining. Whether raised or inset, discontinuity elements 47, 48 may have any desired form. In some embodiments, discontinuity elements may be a plurality of straight elements 47, as shown in FIG. 2. In other embodiments, discontinuity elements may be a plurality of circular elements 48 as shown in FIGS. 3 and 4. Obviously, discontinuity elements 47, 48 may also have other configurations, e.g., a plurality of quadrilateral elements, triangular elements, without thereby departing from the scope of the present disclosure.

Embodiments in accordance with this disclose may also include a plurality of micro-channels or micro-reservoirs between discontinuity elements which allow lubricant to further spread. In some embodiments, a surface of a cavity 45 will be provided with lubricant that will lubricate rolling bodies, e.g., 32, 33 and, consequently, corresponding raceways, keeping contact between rolling bodies and raceways always in optimum lubrication conditions. In this way, therefore, the main object of the present disclosure is achieved, namely that of reducing the rolling friction of the bearing unit.

In accordance with this disclosure, a lubricant used may be lubricating oil or grease. In some embodiments in accordance with this disclosure, a percentage of an area of contact between a retention device 40 and a plurality of rolling bodies 32, 33 may be in a range of between 40% and 70% of an area of contact in an embodiment having the same dimensions but without a plurality of discontinuity elements, e.g., 47, 48, as described herein. (In other words, wherein the area of contact between the retention device and the plurality of rolling bodies is 40%-70% of an area of the contact surface in the absence of discontinuity elements, e.g, 47, 48). Tests have shown that this range demonstrates an optimum compromise between retention capacity and lubrication. In various embodiments, an optimum percentage is 50%. By reducing an area of contact, efficiency of lubricant flow between a plurality of rolling bodies 32, 33 and a retention device 40 is increased, resulting in an improved distribution of lubricant over a greater surface area. Embodiments in accordance with this disclosure thereby reduce friction between rolling bodies, e.g., 32, 33, and raceways of an inner or an outer ring, e.g., 20, 24, 31, of a bearing unit, e.g., 30, improving a working life of bearing unit 30 and reducing damage to rolling bodies, e.g., 32, 33, inner rings, e.g., 20, 24, and outer rings, e.g, 31. A weight of bearing unit 30 is also reduced.

In an embodiment where a plurality of discontinuity elements 47, 48 are raised, a height of a plurality of discontinuity elements 47, 48 may be no greater than 1 mm in order not to weaken excessively a cavity 45 of a retention device 40. In an embodiment where a plurality of discontinuity elements 47, 48 are inset, a depth of the plurality of discontinuity elements 47, 48 may be no greater than 1 mm.

In addition to the exemplary embodiments described herein, it must be understood that there exist numerous other embodiments. It must also be understood that these embodiments are only examples and do not limit either the scope of this disclosure, nor its applications, nor its possible configurations. On the contrary, although the description above allows a person skilled in the art to implement the present disclosure at least according to one of its exemplary embodiments, it must be understood that many variants of the components described are possible, without thereby departing from the scope of the disclosure, as defined in the accompanying claims, interpreted literally and/or in accordance with their legal equivalents.

What is claimed:

1. A bearing unit comprising:
a radially outer ring;
a radially inner ring;
a plurality of rolling bodies interposed between the radially outer ring and the radially inner ring;
a retention device for keeping in position the plurality of rolling bodies, the retention device comprising:
a circular base rib;
a plurality of fingers extending from the base rib and spaced circumferentially about the base rib, the plurality of fingers together with the circular base rib defining a plurality of cavities for holding the plurality of rolling bodies,
a plurality of discontinuity elements disposed about contact surfaces of the plurality of cavities.

2. The bearing unit of claim 1, wherein the plurality of discontinuity elements are raised with respect to the contact surface.

3. The bearing unit of claim 1, wherein the plurality of discontinuity elements comprises a plurality of incisions recessed into the contact surface.

4. The bearing unit of claim 1, wherein a total area of contact between the retention device and the plurality of rolling bodies is between 40% and 70% relative to a device having the same dimensions as the retention device and is devoid of the plurality of discontinuity elements.

5. The bearing unit of claim 2, wherein a height of the plurality of discontinuity elements is less than 1 mm.

6. The bearing unit of claim 3, wherein a depth of the plurality of discontinuity elements is less than 1 mm.

7. The bearing unit of claim 1, wherein the plurality of discontinuity elements comprises a plurality of straight elements.

8. The bearing unit of claim 1, wherein the plurality of discontinuity elements is a plurality of circular elements.

9. The bearing unit of claim 1, wherein the retention device is made of polymeric material.

10. The bearing unit of claim 1, wherein the retention device is made of bronze.

11. The bearing unit of claim 1, wherein the plurality of discontinuity elements reduce respective areas of contact with the plurality of rolling bodies and a plurality of respective contact surfaces of the plurality of cavities.

12. The bearing unit of claim 1, wherein the area of contact between the retention device and the plurality of rolling bodies is 40%-70% of an area of the contact surface.

13. A retention device for retaining a plurality of rolling bodies within a bearing unity, the retention device comprising:
a plurality of partially spherical cavities configured to retain a plurality of rolling bodies;
a contact surface defined by the plurality of partially spherical cavities; and
a plurality of discontinuity elements disposed on the contact surfaces.

14. The retention device of claim 13, wherein the plurality of discontinuity elements are raised with respect to the contact surface.

15. The retention device of claim 13, wherein the plurality of discontinuity elements are inset into the contact surface.

16. The retention device of claim 13, wherein a height of the plurality of discontinuity elements is less than 1 mm.

17. The retention device of claim 13, wherein a depth of the plurality of discontinuity elements is less than 1 mm.

18. The retention device of claim 13, wherein the plurality of discontinuity elements comprises a plurality of straight elements.

19. The retention device of claim 13, wherein the plurality of discontinuity elements is a plurality of circular elements.

20. The retention device of claim 13, wherein the retention device is made of polymeric material or bronze.
